(19) United States
(12) Patent Application Publication
(10) Pub. No.: US 2008/0062298 A1
(43) Pub. Date: Mar. 13, 2008

(54) Document camera

(75) Inventors: Christopher Yen, Chung Ho City (TW); Ying-Ming Hwang, Chung Ho City (TW); Shuen-Chen Shiue, Chung Ho City (TW); Chun-Kai Hsu, Chung Ho City (TW)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: AverMedia Technologies, Inc., Chung Ho City (TW)

(21) Appl. No.: 11/899,856

(22) Filed: Sep. 7, 2007

(30) Foreign Application Priority Data
Sep. 8, 2006 (TW) 95133349

(51) Int. Cl. H04N 5/222

(52) U.S. Cl. 348/333.07; 348/E05.022

(57) ABSTRACT

A document camera includes an image-shooting module and a detachable module. The detachable module is installed under the image-shooting module, wherein the detachable module or the image-shooting module includes a magnetic attraction generator to attract each other such that the detachable module can be attached to the image-shooting module.

### RELATED APPLICATIONS

This application claims priority to Taiwan Application Serial Number 95133349, filed Sep. 8, 2006, which is herein incorporated by reference.

### BACKGROUND

1. Field of Invention

The present invention relates to a document camera for presentation purpose.

2. Description of Related Art

One of the most helpful presentation assistant equipments so far is a projector. As technology advances, various presentation assistant equipments (such as notebook computers and document cameras) show up in the market.

The document camera is able to shoot images of the presentation papers, such that a presenter need not to prepare digital files first before he can project them on a screen. The images shot by the document camera is transferred to a projector directly and is projected on a screen immediately.

As the document camera improves rapidly, various new functions can be added by using a detachable module. For instance, an illumination module may be attached under an image-shooting module to provide a light source.

A conventional illumination module is attached to the image-shooting module by a mechanical fastener set. Several fasteners need to be operated before the illumination module is connected or disconnected with the image-shooting module. It is somewhat inconvenient for users to repeatedly operate fasteners before the illumination module is connected or disconnected with the image-shooting module.

### SUMMARY

It is therefore an objective of the present invention to provide an improved document camera.

In accordance with the foregoing and other objectives of the present invention, a document camera includes an image-shooting module and a detachable module. The image-shooting module includes a metallic housing. The detachable module is installed under the image-shooting module, and includes the following components. A hollow space, through which the image-shooting module shoots an image of a desired target under the detachable module. A metal flux ring encircles the hollow space. A magnetic flux circuit encircles the flux ring. When an electrical current is applied to the magnetic flux circuit, the metal flux ring produces a magnetic force to attract the metallic housing of the image-shooting module.

In accordance with the foregoing and other objectives of the present invention, another document camera includes an image-shooting module and a detachable module. The detachable module is installed under the image-shooting module, wherein the detachable module comprises a magnet ring to attract the metallic member such that the detachable module is attached to the image-shooting module.

In accordance with the foregoing and other objectives of the present invention, the document camera includes a base portion and a rotatable arm. The rotatable arm is pivotally connected to the base portion at one end and to the image-shooting module at the other end. A magnet is disposed under a concave portion of the base portion. A detachable control panel has a metallic member. When the detachable control panel is accommodated in the concave portion, the magnet attracts the metallic member of the detachable control panel.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a side view of a document camera with a detachable module according to one embodiment as described herein;

FIG. 2 illustrates a side view of an image-shooting module of the document camera and a detachable module according to one embodiment as described herein;

FIG. 3 illustrates a side view of an image-shooting module of the document camera and another detachable module according to one embodiment as described herein; and

FIG. 4 illustrates a side view of a document camera with a detachable module according to another embodiment as described herein.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

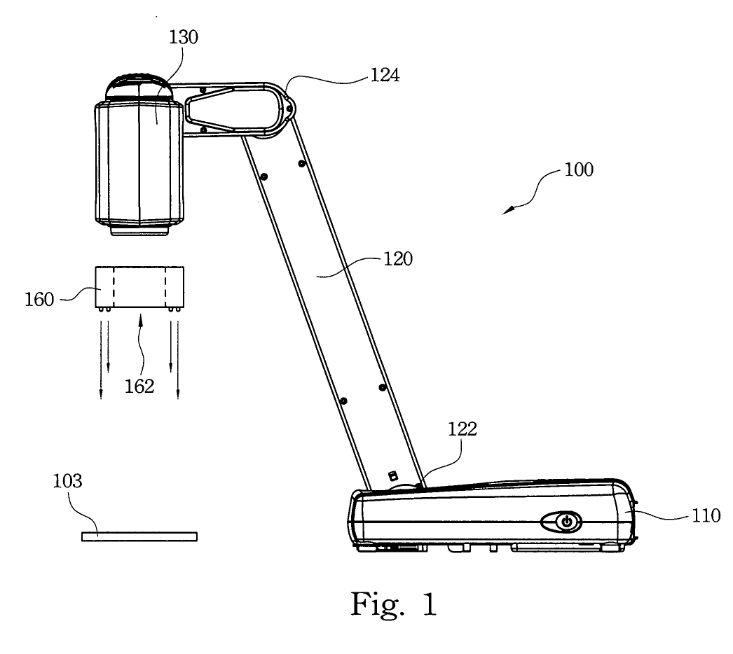

FIG. 1 illustrates a side view of a document camera with a detachable module according to one embodiment as described herein. The document camera 100 includes a base portion 110, a rotatable arm 120 and an image-shooting module 130. The rotatable arm 120 is pivotally connected with the base portion 110 by a joint 122 at one end, and pivotally connected with the image-shooting module 130 by a joint 124 at the other end. Therefore, the image-shooting module can be adjusted in position relative to the base portion 110 by means of the rotatable arm 120, the joint 122 and the joint 124.

The document camera 100 further includes a detachable module 160, which can be taken apart from the image-shooting module 130 by users at will. The detachable module 160 can be a module, which emits light beams to define an image-shooting boundary of the image-shooting module 130. The detachable module 160 can also be an illumination module, which provides desired light source for the image-shooting module 130.

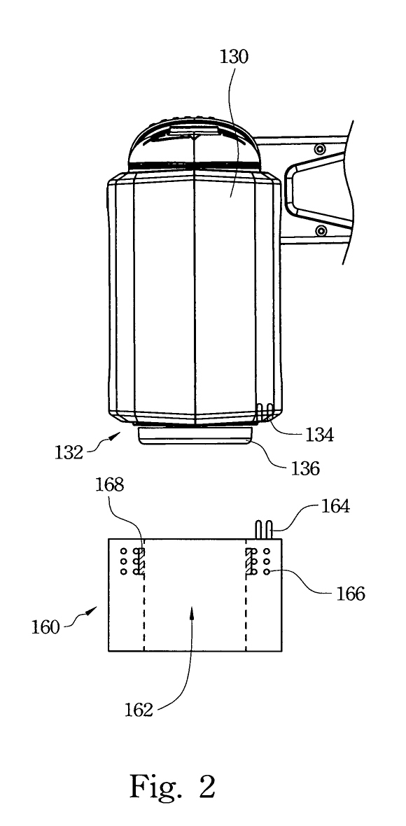

FIG. 2 illustrates a side view of an image-shooting module of the document camera and a detachable module according to one embodiment as described herein. The detachable module 160 is installed under the image-shooting module 130, and has a hollow space 162. The image-shooting module 130 is capable of shooting an image of a desired target 103 under the detachable module 160 through the hollow space 162. In an alternate embodiment, the detachable module 160 may not have the hollow space 162, and may be installed on the side of the image-shooting module 130. Therefore, The image-shooting module 130 can shoot an image of a desired target 103 under the detachable module 160 directly without through the detachable module 160. A metal flux ring 168, which is encircled by a magnetic flux circuit 166, is installed to encircle the hollow space 162. When an electrical current is applied to the magnetic flux circuit 166, the metal flux ring 168 produces a magnetic force to attract a metallic housing 132, a metallic member or a magnet member of the image-shooting module 130. The metallic housing 132 or the metallic member can be made from Fe, Co, Ni or any combination thereof. The image-shooting module 130 has an objective lens set 136, which fits into the hollow space 162 of the detachable module 160 when the detachable module 160 is attached to the image-shooting module 130. Besides, the detachable module 160 further includes a power connection pin 164, and the image-shooting module 130 further includes a power connection hole 134. When the detachable module 160 is attached to the image-shooting module 130, the power connection pin 164 is inserted into the power connection hole 134 for obtaining power to apply to the magnetic flux circuit 166. An ON/OFF switch (not illustrated in drawings) may be installed to turn on or turn off the magnetic flux circuit 166.

In an alternate embodiment, the metal flux ring 168 and the magnetic flux circuit 166 may be installed on the image-shooting module 130, and the detachable module 160 has a metallic member or housing. Thus, the detachable module 160 can also be attached to the image-shooting module 130 by a magnetic attraction.

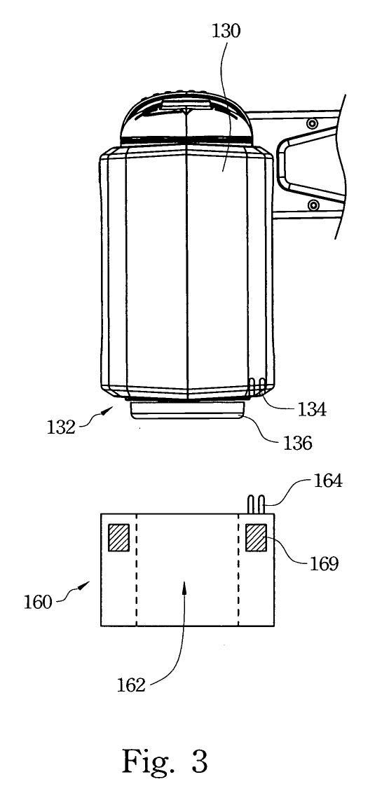

FIG. 3 illustrates a side view of an image-shooting module of the document camera and another detachable module according to one embodiment as described herein. The detachable module 160 is installed under the image-shooting module 130, and has a hollow space 162. The image-shooting module 130 is capable of shooting an image of a desired target 103 under the detachable module 160 through the hollow space 162. In an alternate embodiment, the detachable module 160 may not have the hollow space 162, and may be installed on the side of the image-shooting module 130. Therefore, The image-shooting module 130 can shoot an image of a desired target 103 under the detachable module 160 directly without through the detachable module 160. A magnet ring 169 is installed to encircle the hollow space 162. A magnetic force of the magnet ring 169 attracts a metallic housing 132, a metallic member or another magnet member of the image-shooting module 130. The metallic housing 132 or the metallic member can be made from Fe, Co, Ni or any combination thereof. The image-shooting module 130 has an objective lens set 136, which fits into the hollow space 162 of the detachable module 160 when the detachable module 160 is attached to the image-shooting module 130. Besides, the detachable module 160 further includes a power connection pin 164, and the image-shooting module 130 further includes a power connection hole 134. When the detachable module 160 is attached to the image-shooting module 130, the power connection pin 164 is inserted into the power connection hole 134 for obtaining power.

In an alternate embodiment, the magnet ring 169 may be installed on the image-shooting module 130, and the detachable module 160 has a metallic member or housing. Thus, the detachable module 160 can also be attached to the image-shooting module 130 by a magnetic attraction.

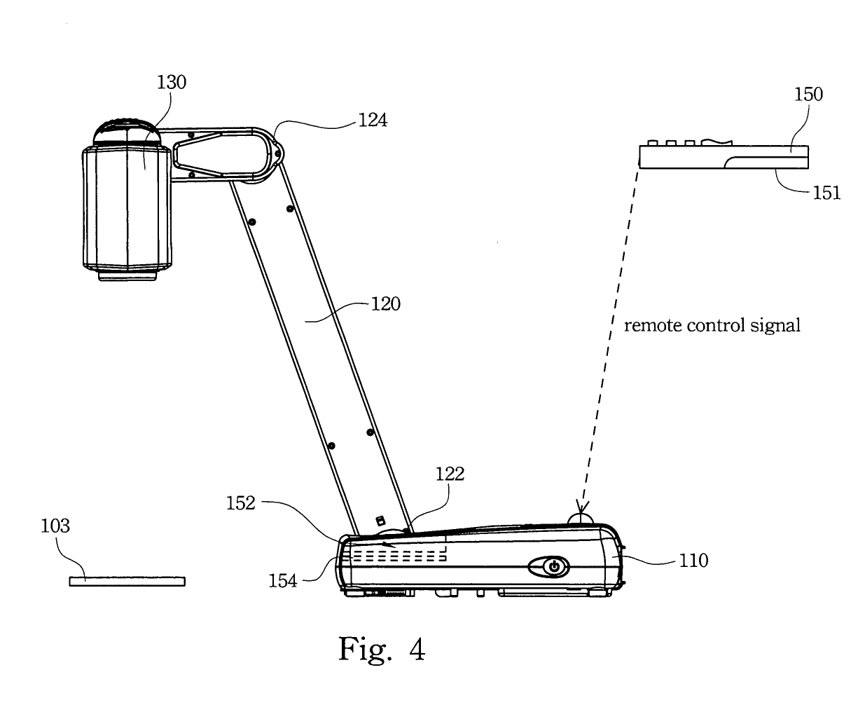

FIG. 4 illustrates a side view of a document camera with a detachable module according to another embodiment as described herein. The document camera 100 includes a base portion 110, a rotatable arm 120 and an image-shooting module 130. The rotatable arm 120 is pivotally connected with the base portion 110 by a joint 122 at one end, and pivotally connected with the image-shooting module 130 by a joint 124 at the other end. Therefore, the image-shooting module can be adjusted in position relative to the base portion 110 by means of the rotatable arm 120, the joint 122 and the joint 124.

The document camera 100 further includes a detachable control panel 150 to control thereof. The detachable control panel 150 can be a remote controller or accommodated in a concave portion 152 to directly control the document camera 100. The detachable control panel 150 includes a metallic housing 151 or a metallic member at its bottom side. The detachable control panel 150 can be taken apart from the base portion 110 or accommodated in a concave portion 152 of the base portion 110. A magnet 154 is installed under the concave portion 152 to magnetically attract the a metallic housing 151 or the metallic member of the detachable control panel 150 such that the detachable control panel 150 is attached to the base portion 110. This embodiment can be combined with the embodiment as illustrated in FIG. 1.

According to embodiments discussed above, a document camera has a detachable module, which is attached to an image-shooting module thereof by a magnetic attraction. Users can conveniently take apart the detachable module from the image-shooting module when the detachable module is idle.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A document camera comprising:
an image-shooting module, comprising a metallic housing; and
a detachable module, installed under the image-shooting module, wherein the detachable module comprising:
a metal flux ring, encircling the hollow space; and
a magnetic flux circuit, encircling the flux ring, when an electrical current is applied to the magnetic flux circuit, the metal flux ring produces a magnetic force to attract the metallic housing of the image-shooting module.

2. The document camera of claim 1, wherein the image-shooting module comprises an objective lens set, which fits into the hollow space when the detachable module is attached to the image-shooting module by the magnetic force.

3. The document camera of claim 1, wherein the detachable module is a module, which emits light beams to define an image-shooting boundary of the image-shooting module.

4. The document camera of claim 1, wherein the detachable module is an illumination module.

5. The document camera of claim 1, wherein he detachable module comprises a hollow space, through which the image-shooting module shoots an image of a desired target under the detachable module.

6. The document camera of claim 1, further comprising:
a base portion, comprising a concave portion;
a rotatable arm, pivotally connected to the base portion at one end and to the image-shooting module at the other end;
a magnet, disposed under the concave portion; and
a detachable control panel, having a metallic housing, the magnet attracting the metallic housing of the detachable control panel when the detachable control panel is accommodated in the concave portion.

7. A document camera comprising:
an image-shooting module, comprising a metallic housing; and
a detachable module, installed under the image-shooting module, wherein the detachable module comprising:
a hollow space, through which the image-shooting module shoots an image of a desired target under the detachable module; and
a magnet ring, encircling the hollow space to attract the metallic housing such that the detachable module is attached to the image-shooting module.

8. The document camera of claim 7, wherein the image-shooting module comprises an objective lens set, which fits into the hollow space when the detachable module is attached to the image-shooting module.

9. The document camera of claim 7, wherein the detachable module is a module, which emits light beams to define an image-shooting boundary of the image-shooting module.

10. The document camera of claim 7, wherein the detachable module is an illumination module.

11. The document camera of claim 7, wherein he detachable module comprises a hollow space, through which the image-shooting module shoots an image of a desired target under the detachable module.

12. The document camera of claim 7, further comprising:
a base portion, comprising a concave portion;
a rotatable arm, pivotally connected to the base portion at one end and to the image-shooting module at the other end;
a magnet, disposed under the concave portion; and
a detachable control panel, having a metallic housing, the magnet attracting the metallic housing of the detachable control panel when the detachable control panel is accommodated in the concave portion.

13. A document camera comprising:
an image-shooting module comprising a metal flux ring and a magnetic flux circuit, wherein the magnetic flux circuit encircles the flux ring; and
a detachable module, installed under the image-shooting module, the detachable module comprising a metallic housing and a hollow space, wherein the image-shooting module shoots an image of a desired target under the detachable module through the hollow space, when an electrical current is applied to the magnetic flux circuit, the metal flux ring produces a magnetic force to attract the metallic housing of the detachable module.

14. The document camera of claim 13, wherein the image-shooting module comprises an objective lens set, which fits into the hollow space when the detachable module is attached to the image-shooting module by the magnetic force.

15. The document camera of claim 13, wherein the detachable module is a module, which emits light beams to define an image-shooting boundary of the image-shooting module.

16. The document camera of claim 13, wherein the detachable module is an illumination module.

17. A document camera comprising:
an image-shooting module comprising a magnet ring; and
a detachable module, installed under the image-shooting module, the detachable module comprising a metallic housing and a hollow space, wherein the image-shooting module shoots an image of a desired target under the detachable module through the hollow space, a magnetic force of the magnet ring attract the metallic housing of the detachable module such that the detachable module is attached to the image-shooting module.

18. The document camera of claim 17, wherein the image-shooting module comprises an objective lens set, which fits into the hollow space when the detachable module is attached to the image-shooting module by the magnetic force.

19. The document camera of claim 17, wherein the detachable module is a module, which emits light beams to define an image-shooting boundary of the image-shooting module.

20. The document camera of claim 17, wherein the detachable module is an illumination module.
